(19) United States
(12) Patent Application Publication
(10) Pub. No.: US 2004/0141066 A1
(43) Pub. Date: Jul. 22, 2004

(54) Digital camera and portable digital device which complement each other's function

(75) Inventors: Seishi Ohmori, Seongnam-si (KR); Jong-Hum Park, Seoul (KR); Junichi Takizawa, Seongnam-si (KR)

Correspondence Address: GARDNER CARTON & DOUGLAS LLP, ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 10/747,998

(22) Filed: Dec. 29, 2003

(30) Foreign Application Priority Data
Dec. 30, 2002 (KR) 2002-87145

(51) Int. Cl. H04N 5/232

(52) U.S. Cl. 348/211.2

(57) ABSTRACT

A digital camera and a portable digital device include communication interfaces, respectively, so that a digital image signal of the digital camera is displayed on a display device of the portable digital device, and a user input signal of the portable digital device is processed by the digital camera.

### BACKGROUND OF THE INVENTION

This application claims the priority of Korean Patent Application No. 2002-87145, filed on Dec. 30, 2002, in the Korean Intellectual Property Office, the disclosure of which is incorporated herein in its entirety by reference.

1. Field of the Invention

The present invention relates to a digital camera and a portable digital device which can complement each other's function. The portable digital device includes a display device and may be a portable phone, a personal digital assistant (PDA), a global positioning system (GPS) terminal, a portable printer, or the like.

2. Description of the Related Art

A typical portable digital device, for example a portable phone disclosed in U.S. Pat. No. 6,317,609, may include a built-in camera and can perform fundamental functions of a digital camera. However, space for the camera is limited when the camera is built into the portable digital device; and therefore, the functions of a typical digital camera cannot be performed properly. For example, neither a flash function, video recording of moving images, nor an optical zoom function of a typical digital camera can be performed. In addition, the image resolution of a typical digital camera cannot be accomplished. For example, a typical portable digital device with a digital camera function has a maximum of 30 thousand pixels. However, a typical digital camera has a maximum of 5 million pixels. Furthermore, high-speed communication with a personal computer cannot be accomplished. For example, a camera built in a portable digital device cannot use standard communication specifications or uses low-speed communication specifications. Conversely, a typical digital camera can communicate with a personal computer at a high speed according to universal serial bus (USB) standard communication specifications.

### SUMMARY OF THE INVENTION

The present invention is directed to a device that satisfies the need to combine the advanced photography and storage features of a typical digital camera with the control capability and versatility of a portable digital device.

An aspect of the present invention provides a digital camera, including an optical system which includes a plurality of lenses to optically process light; a converter which converts the light from the optical system into an electric analog image signal; an analog-to-digital converter which converts the analog image signal of the converter into a digital image signal; a digital signal processor which processes the digital image signal from the analog-to-digital converter; and a communication interface for a portable digital device. Such portable digital device includes a user input unit, a display device, and a controller. A digital image signal from the digital signal processor in the digital camera is displayed on the display device of the portable digital device, and a signal input through the user input unit of the portable digital device is transmitted to the digital signal processor and processed.

Another aspect of the present invention provides a portable digital device including a user input unit, a display device, a controller, and a communication interface for a digital camera. A digital image signal from the digital camera is displayed on the display device, and a signal input through the user input unit is processed by the digital camera.

Because the digital image signal generated by a digital camera can be displayed on the display device of a portable digital device and a user input signal generated by the portable digital device can be processed by the digital camera, the present invention solves the problem of limited space in a portable digital device with a built-in camera and thus have the following advantages:

Advanced functions of a typical digital camera can be utilized when using a portable digital device. For example, after conveniently photographing an image at a high resolution using a flash function and an optical zoom function of the digital camera, the user can transmit the image in the form of a still or moving image file using the portable digital device.

Since a digital image from the digital camera can be displayed on the display device of the portable digital device, the digital camera does not need to have a display.

Since the digital camera can be controlled through the user input unit of the portable digital device, the user input unit of the digital camera can be minimized.

The functions of the portable digital device not found on a typical digital camera can be used in conjunction with the digital camera. For example, an audio signal input through a microphone of the portable digital device can be stored and linked to an image file in the recording medium of the digital camera. In addition, an audio file stored in the recording medium of the digital camera can be reproduced through a speaker of the portable digital device. Accordingly, the digital camera does not need to have a microphone or a speaker.

Since the digital camera does not need to have a display device, a microphone, or a speaker and has a minimized user input unit, the digital camera has sufficient space for the portable digital device, thereby increasing a user's convenience.

Since the portable digital device can be used as a remote control of the digital camera, a user can photograph an image without directly pressing the shutter of the digital camera.

### BRIEF DESCRIPTION OF THE DRAWINGS

The above and other features and advantages of the present invention will become more apparent by describing in detail the preferred embodiments thereof with reference to the following description, claims, and attached drawings in which:

FIG. 1 is a front view of a digital camera mounted with a portable digital device, according to one embodiment of the present invention;

FIG. 2 is a rear view of the digital camera shown in FIG. 1;

FIG. 3 is a diagram showing a state in which a front panel of the portable digital device mounted on the digital camera shown in FIG. 2 is open;

FIG. 4 is a diagram showing a state in which the portable digital device is dismounted from the digital camera shown in FIG. 2;

FIG. 5 is a block diagram showing an internal structure of the digital camera shown in FIG. 2; and

FIG. 6 is a block diagram showing an internal structure of the digital camera shown in FIG. 2.

### DETAILED DESCRIPTION OF THE INVENTION

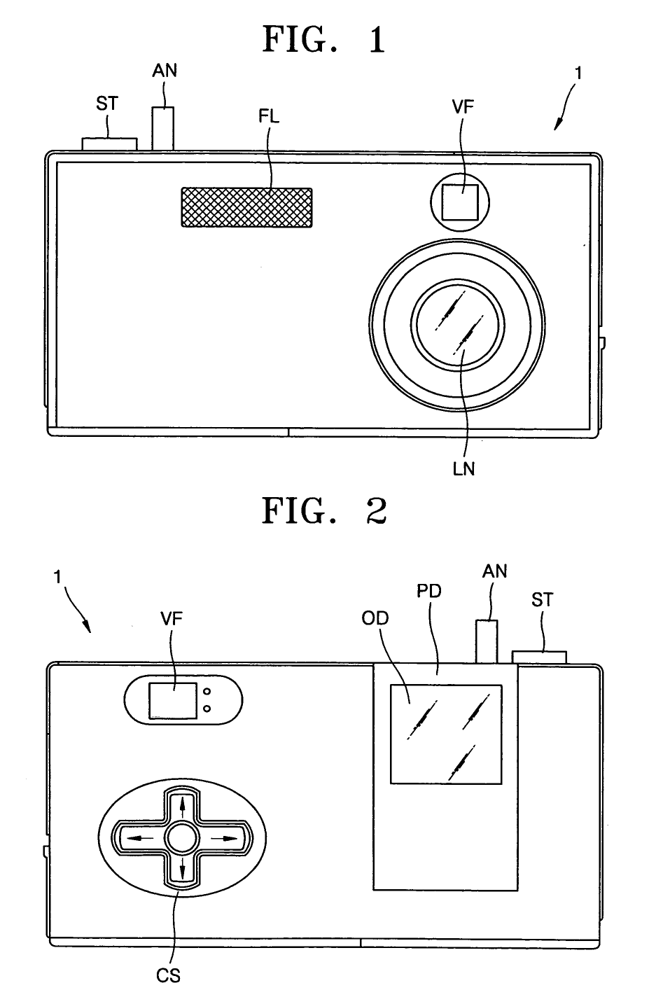

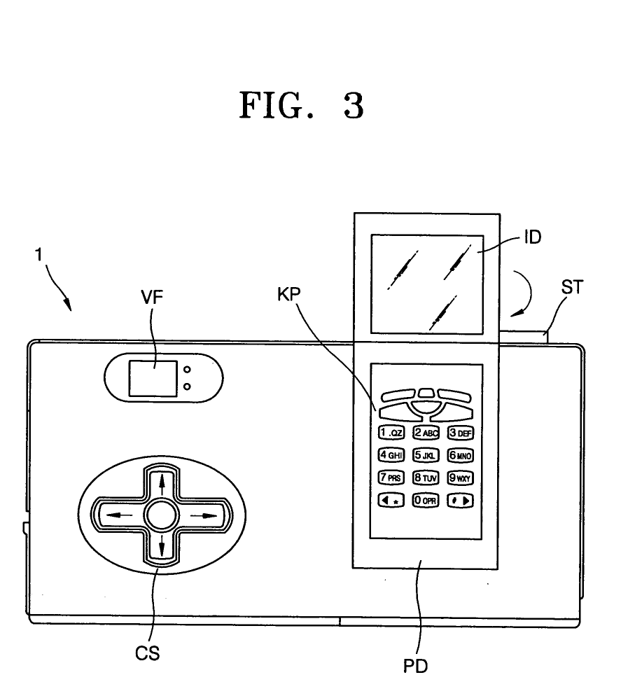

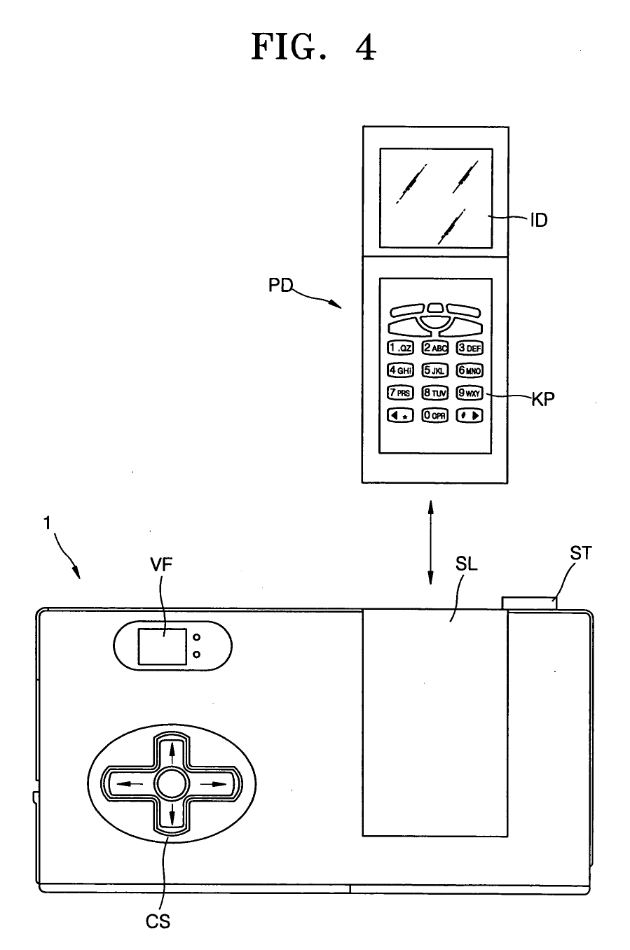

FIG. 1 shows the front of a digital camera 1. FIG. 2 shows the back of the digital camera 1 with a portable digital device PD, for example, a portable phone, according to the one embodiment of the present invention. FIG. 3 shows an embodiment in which the front panel of the portable digital device PD mounted on the digital camera 1 is open. FIG. 4 shows a state in which the portable digital device PD is detached from the digital camera 1.

Referring to FIGS. 1 through 4, the digital camera 1 includes a shutter ST, a flash FL, a view finder VF, and a control input unit CS. The portable digital device PD includes an antenna AN, an external display panel OD provided on the front side of the front panel, an internal display panel ID provided on the rear side of the front panel, and a keypad KP.

Both the digital camera 1 and the portable digital device PD include a communication interface such that a digital image signal from the digital camera 1 is displayed on the internal display panel ID of the portable digital device PD, and a user input signal of the portable digital device PD is processed by the digital camera 1. Since the digital camera 1 can secure a space for the portable digital device PD, the portable digital device PD can be used after being inserted into a slot SL of the digital camera 1. The portable digital device PD can also be used after being detached from the digital camera 1. When the portable digital device PD is mounted on the digital camera 1, a wired communication interface included in the digital camera 1 is connected to a wired communication interface included in the portable digital device PD. When the portable digital device PD is detached from the digital camera 1, a wireless communication interface of the digital camera 1 and a wireless communication interface of the portable digital device PD operate. Interface between the digital camera 1 and the portable digital device PD will be described in detail later.

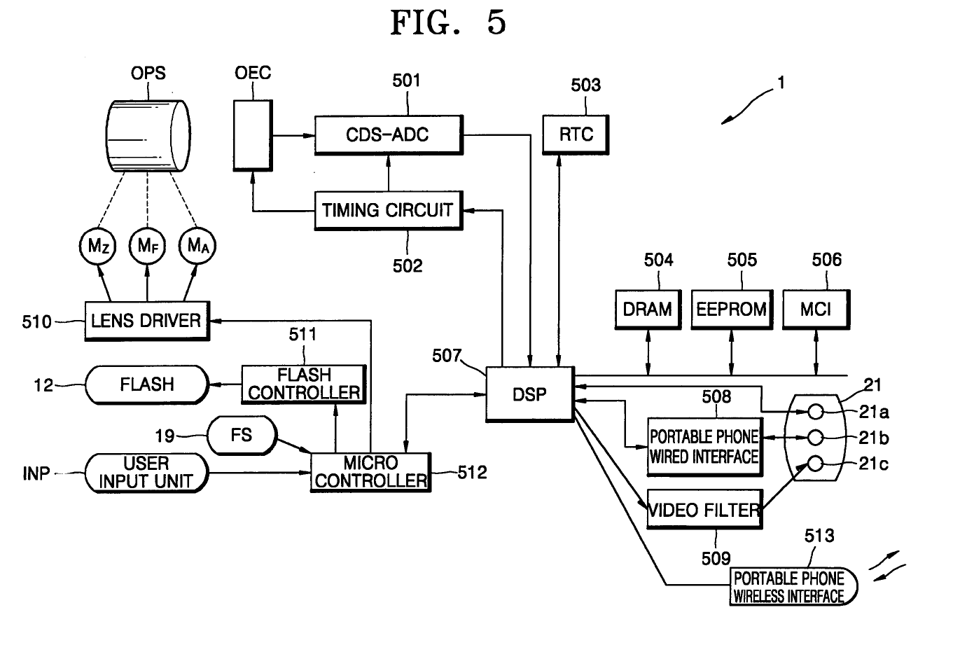

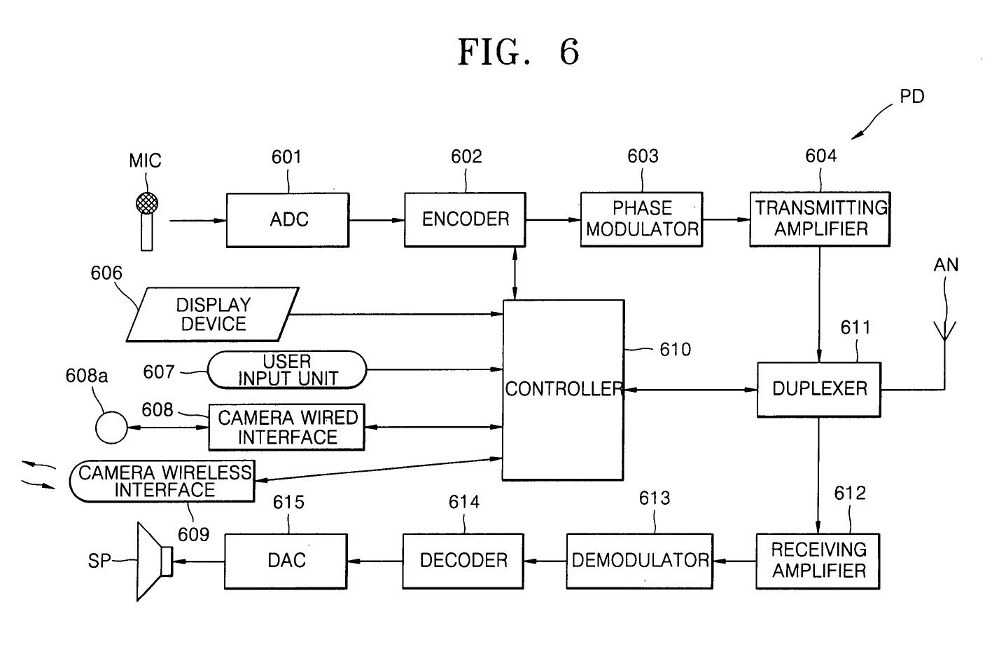

Hereinafter, the structure of the digital camera 1 will be described with reference to FIG. 5.

An optical system OPS including a lens unit (LN shown in FIG. 1) and a filter unit optically processes light from a subject. The lens unit LN of the optical system OPS includes a zoom lens, a focus lens, and a compensating lens.

An optoelectric converter OEC implemented by a charge coupled device (CCD) or a complementary metal-oxide-semiconductor (CMOS) converts light from the optical system OPS into an electric analog image signal. Here, a digital signal processor (DSP) 507 controls a timing circuit 502 to control the optoelectric converter OEC and a correlation double sampler and analog-to-digital converter (CDS-ADC) 501. The CDS-ADC 501 processes an analog image signal received from the optoelectric converter OEC to remove high-frequency noise and adjust the amplitude and then converts the analog image signal into a digital image signal. The DSP 507 processes the digital image signal received from the CDS-ADC 501 to generate a luminance signal and a chrominance signal.

The digital image signal including the luminance and chrominance signals transmitted from the DSP 507 is temporarily stored in a dynamic random access memory (DRAM) 504. An algorithm and setup data which are necessary for the operation of the DSP 507 are stored in an electrically erasable programmable read only memory (EEPROM) 505. A user's memory card is removably installed in a memory card interface (MCI) 506. The MCI 506 stores still or moving image files and audio files, which are compressed by the DSP 507.

A user input unit INP includes the control input unit CS and a shutter button (ST shown in FIG. 1).

A micro controller 512 controls a lens driver 510 such that a zoom motor M_{z}, a focus motor M_{F}, and a aperture motor M_{A} drive the zoom lens, the focus lens, and an aperture, respectively, included in the optical system OPS. The micro controller 512 also controls a flash controller 511 according to a signal received from a flash sensor (FS) 19 to drive a flash 12.

The digital image signal from the DSP 507 can be transmitted in serial communication via a universal serial bus (USB) connector 21a or can be transmitted as a video signal via a video filter 509 and a video output unit 21c. The digital image signal from the DSP 507 can also be transmitted through a portable digital device wired interface 508 and a portable digital device connector 21b, or transmitted through a portable digital device wireless interface 513. As described above, when the portable digital device PD is mounted on the digital camera 1, the wired interface 508 provided in the slot (SL of FIG. 4) of the digital camera 1 is connected to the wired interface 608 included in the portable digital device PD. When the portable digital device PD is detached from the digital camera 1, the portable digital device wireless interface 513 of the digital camera 1 and the wireless interface 609 of the portable digital device PD communicate. The “Bluetooth” protocol is well known as a wireless communication protocol which may be used.

The digital image signal of the DSP 507 is input to a controller 610 of the portable digital device PD via the portable digital device wired interface 508 or the portable digital device wireless interface 513. The controller 610 of the portable digital device PD transmits the digital image signal to a display driver of the portable digital device PD. Accordingly, the digital image signal of the DSP 507 is displayed on the internal display panel (ID shown in FIGS. 3 and 4) of the portable digital device PD.

A user input signal from the keypad (KP shown in FIGS. 3 and 4) in the user input unit 607 of the portable digital device PD is connected to the controller 610 of the portable digital device PD and transmitted from the controller 610 of the portable digital device PD to the DSP 507 through the portable digital device wired interface 508 or the portable digital device wireless interface 513 and processed by the DSP 507. For example, the digital camera 1 can be operated according to a user command signal input to the controller of the portable digital device PD. In addition, an audio signal input through a microphone MIC of the portable digital device PD can be stored in a memory card inserted into the MCI 506 of the digital camera 1.

Referring to FIG. 6, the portable digital device PD shown in FIG. 2 includes a microphone MIC, analog-to-digital converter (ADC) 601, an encoder 602, a phase modulator 602, a transmitting amplifier 604, a duplexer 611, an antenna AN, a display device 606, a user input unit 607 including a keypad (KP shown in FIGS. 3 and 4), a camera wired interface 608 with a camera connector 608a, a camera wireless interface 609, a controller 610, a receiving amplifier 612, a demodulator 613, a decoder 614, a digital-to-analog converter (DAC) 615, and a speaker SP.

The display device 606 is controlled by the controller 610 and includes a display driver, an external display panel (OD shown in FIG. 2), and an internal display panel (ID shown in FIG. 3). The display device 606 displays a signal from the user input unit 607 and a reception message from the duplexer 611. The display device 606 also displays a digital image signal received through the camera connector 608a and the camera wired interface 608 or through the camera wireless interface 609.

The ADC 601 converts an analog audio signal input from the microphone MIC into a digital audio signal. The encoder 602 controlled by the controller 610 encodes the digital audio signal from the ADC 601 for transmission. The phase modulator 603 modulates the phase of the encoded audio signal from the encoder 602 for transmission. The transmitting amplifier 604 amplifies the modulated audio signal from the phase modulator 603. The duplexer 611 controlled by the controller 610 transmits the amplified audio signal from the transmitting amplifier 604 to a base station through the antenna AN.

The receiving amplifier 612 amplifies an audio signal received through the antenna AN and the duplexer 611. The demodulator 613 demodulates the audio signal from the receiving amplifier 612. The decoder 614 decodes the audio signal from the demodulator 613. The digital audio signal from the decoder 614 is converted into an analog audio signal by the DAC 615 and the DAC 615 then drives the speaker SP.

When the portable digital device PD is inserted into the slot SL of the digital camera 1, a digital image signal transmitted through the portable digital device wired interface 508 and the portable digital device connector 21b of the digital camera 1 is input to the controller 610 via the camera connector 608a and the camera wired interface 608. When the portable digital device PD is detached from the digital camera 1, the digital image signal is transmitted through the portable wireless interface 513 of the digital camera 1 and input to the controller 610 via the camera wireless interface 609. Then, the controller 610 controls the display device 606 to display the digital image signal from the digital camera 1 or controls the duplexer 611 to transmit the digital image signal to the base station through the antenna AN.

In addition, the controller 610 transmits signals related to the digital camera 1, e.g., camera command signals, among user input signals from the user input unit 607 to the digital camera 1 through the camera wired interface 608 or the camera wireless interface 609 so that the digital camera 1 processes the signals.

An audio signal input through the microphone MIC can be transmitted to the digital camera 1. More specifically, the portable digital device PD is inserted into the slot SL of the digital camera 1, an audio signal from the microphone MIC can be input to the DSP 507 of the digital camera 1 via the controller 610, the camera wired interface 608, the camera connector 608a, the portable digital device connector 21b, and the portable digital device wired interface 508. When the portable digital device PD is detached from the digital camera 1, an audio signal of the microphone MIC is input to the DSP 507 of the digital camera 1 via the controller 610, the camera wireless interface 609, and the portable digital device wireless interface 513 of the digital camera 1. The DSP 507 then stores the digital audio signal in a memory card through the MCI 506, where the audio file can be linked to an image file.

Conversely, a digital audio signal stored in a memory card of the digital camera 1 can be transmitted to the controller 610 of the portable digital device PD and reproduced through the speaker SP.

Although a few embodiments of the present invention have been shown and described, it will be appreciated by those skilled in the art that changes may be made in these elements without departing from the principles and spirit of the invention, the scope of which is defined in the appended claims and their equivalents.

What is claimed is:

1. A digital camera comprising:
an optical system which includes at least one lens to optically process light from a source;
an optoelectric converter which converts the light from the optical system into an analog image signal;
an analog-to-digital converter which converts the analog image signal of the optoelectric converter into a digital image signal;
a digital signal processor which processes the digital image signal from the analog-to-digital converter; and
a communication interface for a portable digital device, the portable digital device including a user input unit, a display device, and a controller,
wherein a digital image signal of the digital signal processor is displayed on the display device of the portable digital device, and
wherein a user input signal input through the user input unit of the portable digital device is processed by the digital signal processor.

2. The digital camera of claim 1, wherein the digital image signal of the digital signal processor is input to the controller of the portable digital device through the communication interface and is controlled by the controller of the portable digital device to be input to and displayed on the display device of the portable digital device.

3. The digital camera of claim 1, wherein the user input signal is input through the user input unit of the portable digital device to the controller of the portable digital device, transmitted to the digital signal processor through the communication interface, and processed by the digital signal processor.

4. The digital camera of claim 1, further comprising a slot into which the portable digital device is inserted such that the communication interface is connected to a communication interface of the portable digital device when the portable digital device is inserted into the slot.

5. The digital camera of claim 1, wherein the communication interface is a wireless communication interface.

6. The digital camera of claim 1, further comprising a means for storing digital data.

7. The digital camera of claim 6, wherein the digital camera stores an audio signal input through a microphone of the portable digital device.

8. The digital camera of claim 6, wherein the storing means is a memory card.

9. The digital camera of claim 1, wherein the portable digital device is able to operate the digital camera.

10. A digital camera and portable digital device system comprising:
an optical system which includes at least one lens to optically process light from a source;
an optoelectric converter which converts the light from the optical system into an analog image signal;
an analog-to-digital converter which converts the analog image signal of the optoelectric converter into a digital image signal;
a digital signal processor which processes the digital image signal from the analog-to-digital converter;
a communication interface for a portable digital device;
a user input unit;
a display device;
a controller; and
a communication interface for a digital camera,
wherein a digital image signal of the digital camera is displayed on the display device, and a user input signal input through the user input unit is processed by the digital camera.

11. The system of claim 10, wherein the digital image signal of the digital camera is input to the controller through the communication interface and is controlled by the controller to be input to and displayed on the display device.

12. The system of claim 10, wherein the user input signal is input through the user input unit to the controller and transmitted from the controller to the digital camera through the communication interface.

13. The system of claim 10, wherein the portable digital device is inserted into a slot of the digital camera so that the communication interface is connected to a communication interface of the digital camera.

14. The system of claim 10, wherein the communication interfaces are wireless communication interfaces.

15. The system of claim 10, wherein the portable digital device reproduces an audio signal stored in the digital camera.

15. The system of claim 10, wherein the portable digital device reproduces an audio signal detected by the digital camera.

16. The system of claim 10, wherein a user can use the portable digital device to operate the digital camera.
